(19) United States
(12) Patent Application Publication
(10) Pub. No.: US 2015/0094239 A1
(43) Pub. Date: Apr. 2, 2015

(54) Hydraulic Fracturing Method and Fluid Including In-Situ Boron-Laden Produced Waters

(71) Applicant: Rockwater Energy Solutions, Houston, TX (US)

(72) Inventors: David N. Harry, Katy, TX (US); Fati Malekahmadi, Houston, TX (US); Christopher Gallagher, The Woodlands, TX (US)

(73) Assignee: Rockwater Energy Solutions, Houston, TX (US)

(21) Appl. No.: 14/039,510

(22) Filed: Sep. 27, 2013

(51) Int. Cl. C09K 8/68

(52) U.S. Cl. CPC C09K 8/685
USPC 507/217; 507/211

(57) ABSTRACT

A method of forming a fracturing fluid including mixing produced water or boron-containing oilfield water having an in-situ boron concentration greater than about 20 mg/L at the time of mixing with a hydratable boron crosslinkable polymer to form a fracturing fluid.

### BACKGROUND

Water produced from oil and gas wells (“produced water”) may include formation water, injected water from secondary recovery (waterflooding) operations, and flowback water from completion and remedial operations. Produced-water may include, for instance, petroleum hydrocarbons, suspended and dissolved solids, acid-carbonate reaction by-products from perforation and near-wellbore acidizing operations, spent frac fluid additives, and residual production chemicals. The term “produced water,” for purposes of this disclosure, includes all waters originating in or once having been injected into a subterranean formation, is produced from a subterranean formation. Subterranean formations include, but are not limited to, aquifers providing water suitable for drinking or irrigation, a brackish or brine-water water, or hydrocarbon bearing zones.

Produced water may be recycled for hydraulic fracturing applications to reduce the quantity of water being disposed, to reduce the quantity of fresh water consumption, and to provide economic advantages to operators in terms of outright cost of water as well as to logistical and other water management costs associated with purchasing, moving, and storing freshwater. Boron in produced water may be problematic in produced water recycling for fracturing applications because the boron remains in solution in the recovered water, and may participate in crosslinking the polymer solution formed in the produced water. This ‘recovered’ boron may compete with the boron purposefully added as the crosslinker. The unintended consequence of adding boron crosslinker according to the requirements of a fracturing fluid recipe to a polymer solution formed in produced water having more than about 10 mg/L boron (as B) may cause the fluid to crosslink prematurely, and/or over-crosslink. Boron may be reduced by reverse osmosis, contact with a treated resin, or distillation methods. Typically, operators seek waters with boron levels less than about 10 mg/L boron (as B) for use as hydraulic fracturing fluid water-sources, i.e., frac make-up waters. A boron level of 10 mg/L or less is generally regarded as sufficiently low so as not to interfere with fracturing fluid performance.

### SUMMARY

In one embodiment of the present disclosure, a method of forming a fracturing fluid is disclosed. The method includes mixing produced water or boron-containing oilfield water having an in-situ boron concentration greater than about 20 mg/L at the time of mixing with a hydratable boron crosslinkable polymer to form a fracturing fluid.

In another embodiment of the present disclosure, a fracturing fluid is disclosed. The fracturing fluid includes produced water or boron-containing oilfield water having an in-situ boron concentration greater than about 20 mg/L and a hydratable boron-crosslinkable polymer.

In another embodiment of the present disclosure, a method of manufacturing a fracturing fluid is disclosed. The method includes determining the in-situ concentration of boron of produced water or boron-containing oilfield water having an in-situ boron concentration greater than about 20 mg/L and mixing produced water or boron-containing oilfield water with a hydratable crosslinkable polymer, wherein the in-situ boron concentration of the produced water or boron-containing fresh water is greater than about 20 mg/L at the time of mixing to form a water/polymer mixture. The method also includes determining the difference between the concentration of boron in the produced water or boron containing fresh water and the desired boron concentration of the fracturing fluid and adding a boron compound to the water/polymer mixture to form a fracturing fluid.

In still another embodiment of the present disclosure, a method of manufacturing a fracturing fluid is disclosed. The method includes determining a desired performance characteristic for the fracturing fluid and mixing produced water or boron-containing oilfield water having an in-situ boron concentration greater than about 20 mg/L with a hydratable crosslinkable polymer, wherein the in-situ boron concentration of the produced water or boron-containing fresh water is greater than about 20 mg/L at the time of mixing to form a water/polymer mixture. The method further includes adding a boron compound to the water/polymer mixture to form a fracturing fluid with the desired performance characteristic.

In another embodiment of the present disclosure, a method of manufacturing a fracturing fluid is disclosed. The method includes determining the in-situ concentration of boron of produced water or boron-containing oilfield water having an in-situ boron concentration greater than about 20 mg/L and mixing produced water or boron-containing oilfield water with a hydratable crosslinkable polymer, wherein the in-situ boron concentration of the produced water or boron-containing fresh water is greater than about 20 mg/L at the time of mixing to form a water/polymer mixture. In addition, the method includes determining the difference between the concentration of boron in the produced water or boron containing fresh water and the desired boron concentration of the fracturing fluid and forming a diluted produced water stream, wherein the diluted produced water stream has an in-situ boron concentration of great than about 20 mg/L. The method further includes adding the diluted produced water stream to the water/polymer mixture to form a fracturing fluid.

### BRIEF DESCRIPTION OF THE DRAWINGS

The present disclosure is best understood from the following detailed description when read with the accompanying figures.

FIG. 1 is a plot of viscosity versus time and temperature of a Distilled water (Control) and a low boron (<10 mg/L) “Fresh” water fracturing fluid as described in Example 1.

FIG. 2 is a plot of viscosity versus time and temperature of a Flowback water fracturing fluid as described in Example 2.

FIG. 3 is a plot of viscosity versus time and temperature of a Formation water fracturing fluid as described in Example 2.

FIG. 4 is a plot of viscosity versus time and temperature (220° F.) of two Formation-water borate crosslinked fracturing fluids using 1 gallon of crosslinker per 1000 gallons of fracturing fluid equivalent as described in Example 4.

FIG. 5 is a plot of viscosity versus time and temperature (185° F.) of a Formation-water borate crosslinked fracturing fluids using 1 gallon of crosslinker per 1000 gallons of fracturing fluid equivalent as described in Example 5.

### DETAILED DESCRIPTION

A detailed description will now be provided. The description includes specific embodiments, versions and examples, but the disclosure is not limited to these embodiments, versions or examples, which are included to enable a person having ordinary skill in the art to make and use the disclosure when that information is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

Oilfield waters may be waters produced from wells constructed for the extraction of oil or gas (i.e., produced water) or may be potable, pond, irrigation, sea water, etc., brought to an oilfield location for use in an oilfield treatment. Boron may be naturally present in oilfield waters as boric acid, inorganic borates, and organic borates. Except for boron intentionally added to serve as a crosslinker for a guar or derivatized guar-based hydraulic fracturing fluid, the total boron present in oilfield water is termed “in-situ boron” for purposes of this disclosure. Without being bound by theory, it is believed that some portion of the in-situ boron may be unavailable to participate in reactions with, for example, hydratable crosslinkable polymers such as guar and guar derivatives. Such non-participative boron is termed “sequestered boron” for purposes of this disclosure. Boron present and available to participate in crosslinking reactions with hydrated guar or guar derivatives is termed “available boron” for purposes of this disclosure. Therefore, “in-situ boron” (Bᵢₛ) equals “available boron” (Bₐ) plus “sequestered boron” (Bₛ).

(Bᵢₛ)=(Bₐ)+(Bₛ)

For purposes of this disclosure, boron intentionally added to water (to serve as a crosslinker) is referred to as B_{XL}. The total boron content (B_{T}) of a boron crosslinked hydraulic fracturing fluid would therefore be:

(B_{T})=(Ba)+(Bs)+(BXL)

For fracturing fluids currently in use, (Bis) is no greater than about 10 mg/L even though the intentionally-added boron content to affect fracturing fluid performance may range from 50 mg/L to 2000 mg/L, from 75 to 1000 mg/L, or greater than 100 mg/L. (Fu, et al., U.S. Pat. No. 7,888,295).

Certain embodiments of the present disclosure are directed to a method by which the available boron may be utilized as a source of boron to form a borate crosslinked fracturing fluid. Certain embodiments of the present disclosure are directed to a method by which the available boron found in produced water and in-situ boron-containing oilfield waters having boron contents greater than about 10 mg/L boron may be utilized as a source of boron to form a borate crosslinked fracturing fluid.

In-situ boron content of produced water and boron-containing oil field waters may be above 20 mg/L, from 20 mg/L to 2000 mg/L, from 20 mg/L to 660 mg/L, from around 50 mg/L to 250 mg/L, or about 150 mg/L. The in-situ boron content may depend upon the source of the produced water or boron-containing oilfield water. For instance, produced water that is flowback from a fracturing operation in which boron was intentionally added as a crosslinker may contain more boron per liter of water than that of water originating in the formation.

In certain embodiments of the present disclosure, a fracturing fluid is formed by adjusting the in-situ boron concentration of produced water and boron-containing oilfield water to a desired concentration, wherein the produced water and boron-containing oilfield water has an in-situ concentration of boron at the time of formation of the fracturing fluid of at least 20 mg/L. The desired concentration of boron in the fracturing fluid varies depending on a number of factors including, for instance, the type of hydratable crosslinkable polymer, and formation characteristics. Examples of hydratable crosslinkable polymers include, but are not limited to guar, hydroxyethyl guar (HEG), hydroxypropyl guar (HPG), carboxymethyl guar (CMG), carboxymethylhydroxyethyl guar (CMHEG), carboxymethylhydroxypropyl guar (CMHPG) and mixtures thereof. In certain embodiments of the present disclosure, cellulose derivatives are not used as hydratable crosslinkable polymers. Boron concentrations in guar-based fracturing fluids vary with polymer loading, pH, treating temperature, target crosslinked viscosity, and so on. For instance, in certain embodiments of the present disclosure where the desired concentration of boron in the fracturing fluid is less than the measured in-situ boron, the concentration of in-situ boron may be adjusted to some concentration greater than about 20 mg/L by diluting the produced water or boron-containing oilfield water with oilfield water containing less than 20 mg/L boron. In other embodiments, where the desired concentration of boron in the fracturing fluid is greater than the measured in-situ boron, boron compounds may be added to the produced water or boron-containing fresh water to reach the desired boron concentration. The water soluble boron compounds which are suitable to be added include, but are not limited to, boric acid, inorganic borates such as alkali metal borates, alkaline earth metal borates, alkali metal alkaline earth metal borates, perborates, organic borates, such as boron esters, and mixtures thereof.

In certain embodiments of the present disclosure, for instance, where sequestered boron is present, the fracturing fluid may be formed by first determining the desired boron content of the fracturing fluid. The available boron of the produced water or boron-containing oilfield water may then be determined. Boron may then be added to the produced water or boron-containing oilfield water as necessary to make up the shortfall between the desired boron content of the fracturing fluid and the boron content of the produced water or boron-containing oilfield water to be used as the frac make-up water. In other embodiments, the boron compound may be added until a desired crosslink performance characteristic is reached. After the other components of the fracturing fluid are added, the performance characteristics of the fracturing fluid may then be evaluated, and once determined to be substantially equal to the intended performance of the fracturing fluid containing no more than about 10 mg/L in-situ boron, introduced down-hole. Examples of other components of a frac fluid include, but are not limited to, salts, buffers, clay stabilizers, polymer stabilizers, surfactants, non-emulsifiers, de-foamers, foamers, proppants, friction reducers, biocides, oxygen scavengers, scale-inhibitors, and breakers. An example of a performance characteristic that may be evaluated to assess the contribution of the in-situ boron is the crosslinked viscosity of the frac fluid as evaluated versus time under down-hole conditions. Practitioners of ordinary skill in the art in formulating and evaluating hydraulic fracturing fluids are familiar with the myriad of additives that might comprise a fracturing fluid and methods of evaluating their crosslinked viscosity performance.

In the event the fracturing fluid is not functioning as desired, the boron content may be adjusted. Reasons the fracturing fluid may not be functioning as desired include, for example, the relative portion of in-situ boron which might play into crosslinking versus the portion that is sequestered might be excessive or deficient, the relative sensitivity of the boron content of specially formulated borate crosslinked fracturing fluids already highly variable given the wide array of commercial boron sources for crosslinkers, polymer loading, water quality characteristics such as alkalinity or hardness, pH, bottom-hole temperature, breaker type and quantities, pump rates, etc. which vary from frac company to frac company and to adjustments made to address challenges unique to the well to be treated. When significant amounts of boron in the fracturing fluid are present as sequestered boron, additional boron may be added to the fracturing fluid to make up for the absence of available boron. This evaluation process may be iterative or sequential. In iterative processes, the difference between the desired boron content of the fracturing fluid and the boron content of the produced water or boron-containing oilfield water is determined. A first pre-determined amount of boron may then be added to the produced water or boron-containing oilfield water to attempt to achieve the performance characteristic desired. The performance characteristic of the fracturing fluid is then evaluated. If the performance characteristic of the fracturing fluid has not been achieved, a second pre-determined amount of boron or water containing less than 10 mg/L boron may be added to achieve the desired performance characteristic. The second pre-determined amount of boron will vary depending on the difference between the measured performance characteristic and the desired performance characteristic. In a sequential addition processes, it may be determined by evaluation of the performance characteristic that there are inadequate levels of available boron in the produced water, and boron is added in some amount sequentially with each performance evaluation until the desired performance characteristic is achieved. A sequential addition approach may be followed by an iterative approach to optimize the amount of additional boron to be added. The concentration of boron in the final fracturing fluid may range from 50 mg/L to 2000 mg/L, or from 75 mg/L to 1000 mg/L, or greater than 100 mg/L.

In certain embodiments of the present disclosure where the pH of the produced water or boron-containing oilfield water may be greater than 8.5, the pH of the produced water or boron-containing oilfield water may be adjusted prior to addition of the boron. For instance, the pH of the produced water or boron-containing oilfield water may be reduced to less than about 8.0, to between about 5.0 and 6.5 or between about 5.5 and 6.0. Reducing the pH may be advantageous to maximize the rate at which the guar and/or derivatized guar polymers will develop viscosity once they are added to the water. Lowering the pH to less than about 8.0 also prevents the premature crosslinking (i.e., gelation) of the polymer by the in-situ boron. The boron, and, in certain embodiments, other frac fluid components, may also be added once the pH has been adjusted. Following boron addition, the pH of the frac fluid may then be re-adjusted to reach the desired pH for crosslinking, for instance, at or above a pH of about 8.0 or between a pH of 8.5 to 12. Basic compounds which may be used to raise the pH to 8.0 or above include, but are not limited to, sodium and potassium hydroxide, sodium and potassium carbonate, and sodium bicarbonate. The basic compound is employed in an amount sufficient to neutralize the acidic pH of the fluid and render the fluid alkaline. Other compounds which can be employed include basic compounds that have a characteristic delayed solubility rate in the aqueous fluid such as magnesium oxide, barium oxide, calcium oxide and/or other basic compounds treated or coated with a material (e.g., a wax, etc.) to delay the effect on the pH of the aqueous fluid.

In certain embodiments, the produced water or boron-containing oilfield water may contain “hard-water” divalent cations such as Ca, Mg, Ba, and/or Sr. These ions may interfere with the operation of the fracturing fluid and the produced water may be treated or “softened” to prevent or reduce the concentration of divalent cations in the produced water. These water softening methods may include ion exchange, precipitation, and addition of chelating or sequestering agents. Non-limiting examples of methods of water softening may be found in U.S. Pat. No. 5,226,481, Method For Increasing The Stability Of Water-based Fracturing Fluids, issued Jul. 13, 1993, and which is incorporated herein by reference.

In other embodiments, undesirable organics, turbidity, color and metals may be present in the produced water or boron-containing oilfield water. In such embodiments, treatment of the produced water or boron-containing oilfield water may be performed to remove or reduce undesirable organics, turbidity, color, and metals by such methods as coagulation, flocculation, filtration, and separation. Produced water or boron-containing oilfield water may also be treated with anti-bacterial agents to kill unwanted bacteria in the water. While water treatment practices well known to those of ordinary skill in the art may improve the performance of a fracturing fluid composition in a given water quality, any treatment process which does not reduce the boron content of an oilfield water to less than 20 mg/L could benefit from the teaching contained herein.

### The Waters

Three untreated oilfield water samples were collected. A series of guar hydration studies and borate crosslinked fluid viscosity tests were performed with each of the three waters, as well as with distilled water, the latter to be used as a ‘Control.’ The results of the evaluation of these three oilfield waters are provided in the Examples below.

### EXAMPLES

In the following Examples, Sample 1 is a low TDS (<1,000 mg/L), low-boron (<10 mg/L) “fresh” oilfield water often used as a frac make-up water. Sample 2 is produced flowback water collected several weeks following a hydraulic fracturing treatment using the “fresh” oilfield water from which Sample 1 was collected. Sample 2 flowback water contained 145 mg/L boron (as B). Sample 3 is produced formation water taken from an offset well producing from the same subterranean formation as the hydraulically fracture-treated well from which Sample 2 was collected. Sample 3 formation water contained 126 mg/L boron (as B). The water quality characteristics of each of these waters are found in Table 1. The Control Sample is distilled water.

TABLE 1

| | | Sample 1 | Sample 2 | Sample 3 |
|---|---|---|---|---|
| ANALYTE | Units | Freshwater | Flowback | Formation |
| ORGANICS | | | | |
| Total Petroleum Hydrocarbons (TPH) | mg/L | 0.0 | 3.8 | 290 |
| nC6 to nC12 | mg/L | 0.0 | 1.7 | 140 |
| nC12 to nC28 | mg/L | 0.0 | 2.1 | 150 |
| nC28 to nC35 | mg/L | 0.0 | 0.0 | 0 |
| Total Organic Carbon (TOC) | mg/L | 0.9480 | 2,080 | 1,160 |
| ORGANICS-VOLATILE | | | | |
| Benzene | ug/L | 0.59 | 270 | 650 |
| Ethylbenzene | ug/L | 0.00 | 34 | 88 |
| Toluene | ug/L | 0.93 | 750 | 790 |
| o,m,p-Xylene | ug/L | 0.00 | 600 | 700 |
| Total BETX | ug/L | 1.50 | 1,700 | 2,200 |
| INORGANICS-CATIONS (& Crosslinking Metals) | | | | |
| Calcium | mg/L | 127 | 239 | 149 |
| Magnesium | mg/L | 63.4 | 191 | 102 |
| Barium | mg/L | 0.135 | 98.5 | 180 |
| Strontium | mg/L | 13.1 | 17.9 | 26 |
| Iron | mg/L | 0.793 | 22 | 73.2 |
| Aluminum | mg/L | 0.00749 | 0.307 | 0.0777 |
| Boron | mg/L | 0.613 | 145 | 126 |
| Sulfur | mg/L | 40.7 | 15.5 | 10.1 |
| Manganese | mg/L | 0.068 | 0.717 | 1.09 |
| INORGANIC-ANIONS (& Oxyanions) | | | | |
| Chloride | mg/L | 12.3 | 6,680 | 10,400 |
| Bicarbonate Alkalinity (as CaCO3) | mg/L | 572 | 499 | 542 |
| Total Alkalinity (as CaCO3) | mg/L | 572 | 499 | 542 |
| Sulfate | mg/L | 129 | 97.6 | 10.9 |
| GENERAL | | | | |
| pH | | 7.9 | 5.74 | 6.99 |
| Carbohydrates | mg/L | 0.00 | 87 | 57 |
| Total Dissolved Solids (Residue, Filterable) | mg/L | 702 | 14,200 | 18,900 |
| Total Solids | mg/L | 696 | 14,100 | 19,200 |
| Total Suspended Solids | mg/L | 0 | 0 | 300 |

### Example 1

### Comparison of Sample 1 to the Control Sample

Two fracturing fluids were made. For the Control, 250 ml of distilled water served as the frac make-up water. A second fracturing fluid was made using 250 ml of Sample 1 (Table 1. Freshwater) water. Sample 1 Freshwater is a low TDS (<1,000 mg/L), low-boron (<10 mg/L) “fresh” oilfield water often used as a frac make-up water. The two fracturing fluids were identically formulated except for the water. Each included water, guar, hydration buffer, gel stabilizer, pH buffer, and crosslinker. The crosslinked fluid viscosity of the two fracturing fluids was evaluated on a Grace M5500 HTHP Viscometer using ISO 13503-1 (Sep. 1, 2003), Part 1: Measurement of Viscous Properties of Completion Fluids. The test temperature was selected to be 220° F.

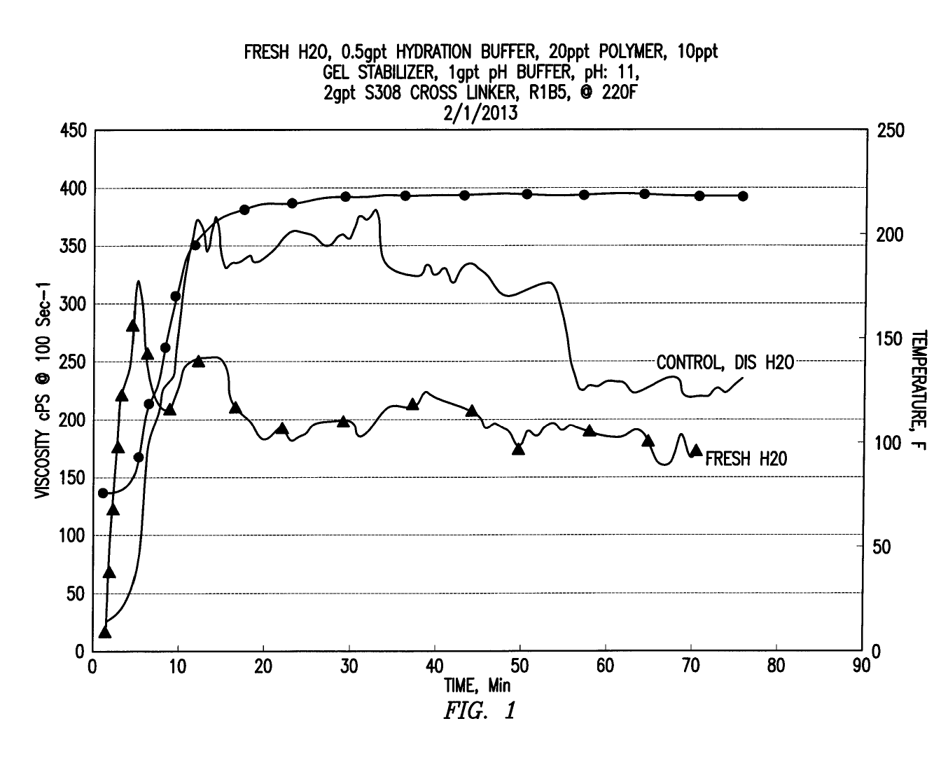

The results of the fluid performance evaluation for the Control (distilled water) and the Sample 1 “Freshwater” are shown in FIG. 1. With respect to FIG. 1, the in situ boron (as B) content of each of the waters is <10 mg/L, and the total boron content (as B) of each of the crosslinked fracturing fluids is 130 to 143 mg/L. The “Control” fluid formed from the distilled water, provided for a maximum viscosity of about 375 centipoise (cPs), and a viscosity of about 230 cPs at 60 minutes. The Freshwater fracturing fluid formed from Sample 1 water provided for a maximum viscosity of about 320 cPs, a sustainable viscosity of about 200 cPs for most of the 60 minute test period, and a viscosity of about 185 cPs at 60 minutes. While the Freshwater fluid did not develop the same high viscosity profile provided by the distilled water, the freshwater fluid performance was suitable for use in hydraulic fracturing treatment application. In each of the Control and Freshwater borate crosslinked fracturing fluids shown in FIG. 1, two (2) gallons of borate crosslinker S-308 per 1000 gallons equivalent of the fracturing fluid were used. S-308 is a borate crosslinker available from Rockwater Energy Solutions, Houston, Tex. S-308 contains about 21 to about 23 percent by weight boron as B₂O₃. By calculation, the boron content (as B) of the S-308 crosslinker is between about 6.52% and 7.14%, and, also, therefore, by calculation, the boron content of the Control and Freshwater borate crosslinked fracturing fluids containing 2 gpt equivalent of the crosslinker would be between about 130 mg/L and 143 mg/L.

### Example 2

### Evaluation of Flowback and Formation Waters

Frac-fluids were made from sample waters 2 (Flowback water) and 3 (Formation water). The two frac fluids were manufactured using the same fracturing fluid formulation used in Example 1. The fluids of Example 2 were evaluated described in Example 1. As in example 1, the test temperature was selected to be 220° F.

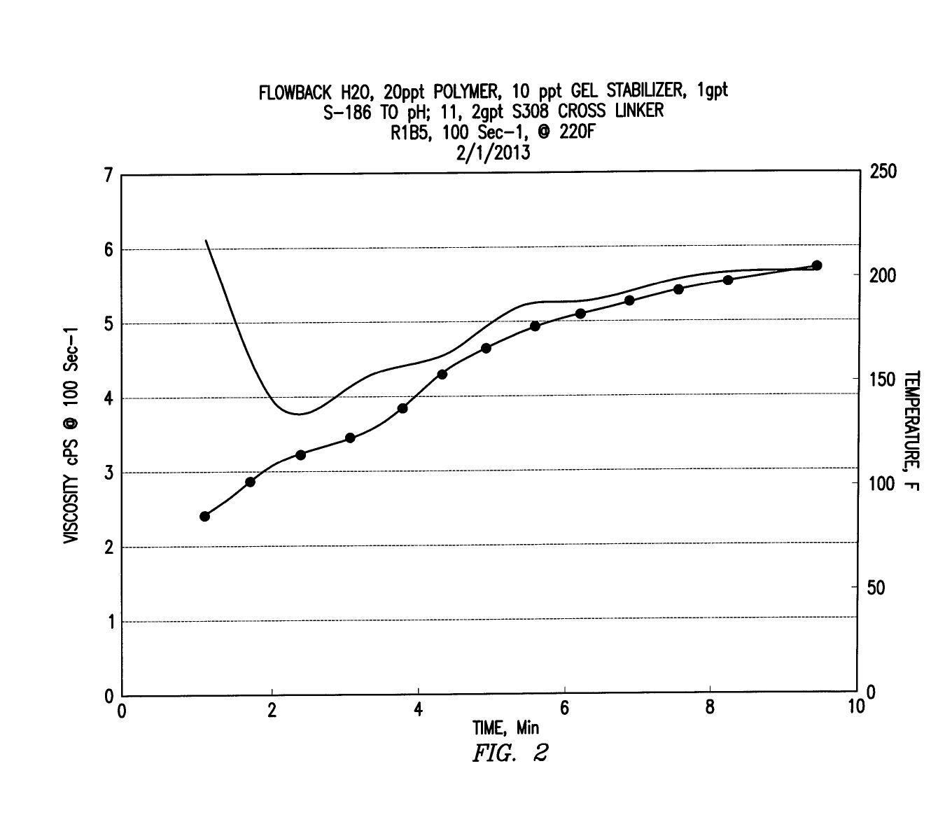

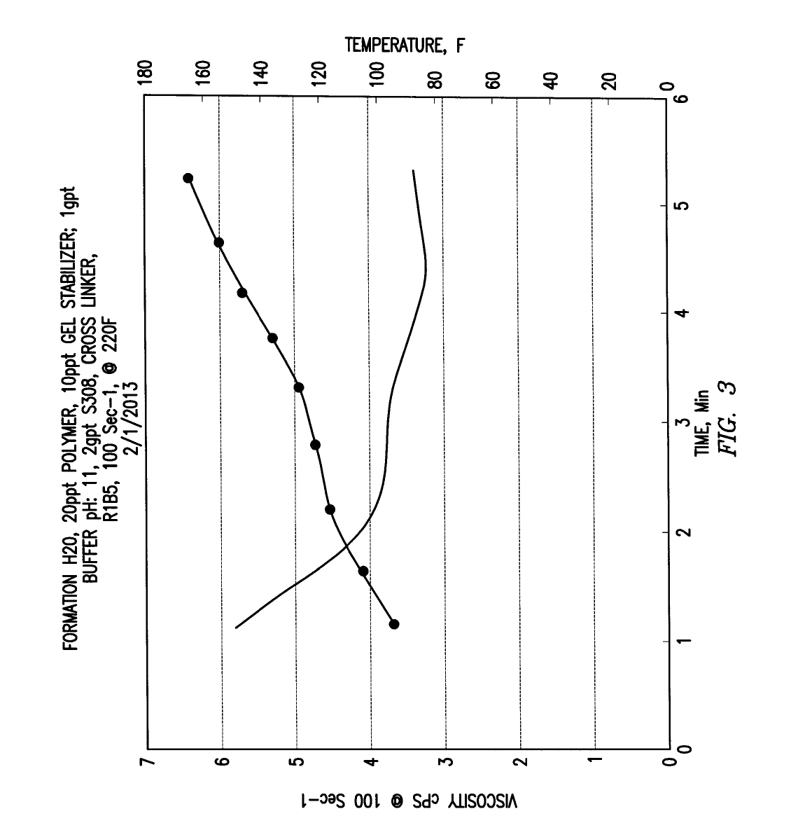

In each of the Flowback and Formation water borate crosslinked fracturing fluids shown in FIGS. 2 and 3, respectively, two (2) gallons of borate crosslinker S-308 per 1000 gallons equivalent of the fracturing fluid were used. As shown in FIG. 2, the in-situ boron (as B) content of the Flowback water is 145 mg/L, and the total boron (as B) content of the crosslinked fracturing fluid is 275 to 290 mg/L. As shown in FIG. 3, The in-situ boron (as B) content of the Formation water is 126 mg/L, and the total boron (as B) content of the crosslinked fracturing fluid is 255 to 270 mg/L. S-308 is a borate crosslinker available from Rockwater Energy Solutions, Houston, Tex. S-308 contains about 21.0 and about 23.0 percent by weight boron as B₂O₃. By calculation, the boron content (as B) of the S-308 crosslinker is between about 6.52% and 7.14%. By calculation, the boron content added by means of the crosslinker to the fracturing fluids comprising Flowback and Formation water was between about 130 mg/L and 143 mg/L.

The results of the fluid performance evaluation are shown in FIGS. 2 and 3. The fracturing fluid formed from the Sample 2 provided for a maximum viscosity of about 6 centipoise (cPs), and no measureable viscosity at 60 minutes. The fracturing fluid formed from the Sample 3 water source also provided for a maximum viscosity of about 6 cPs, and, again, no measureable viscosity at 60 minutes. The results of this test illustrate that neither the Flowback nor the Formation water-based fracturing fluids develop crosslinked viscosities as high or as sustainable as that of the “Fresh” water fracturing fluid of Example 1. Given the analytical determinations of the boron contents of the Flowback and Formation waters as 145 mg/L and 126 mg/L, respectively, the total boron content of the fracturing fluids made from these waters was between about 255 mg/L and 270 mg/L for the Formation water-based fluid, and 275 mg/L and 290 mg/L for the Flowback water-based fluid.

### Example 3

### No Boron Addition

As with Example 2, a portion of sample 3 (Formation water) and sample 4 (Flowback water) were evaluated as a water source for a fracturing fluid on a Grace M5500 HTHP Viscometer using methods referenced in ISO 13503-1 (Sep. 1, 2003), Part 1: Measurement of Viscous Properties of Completion Fluids. The fracturing fluids comprised sample 3 and sample 4 water, respectively, and all the additives used in the previous examples and at the same concentrations, except that no crosslinker was added. The boron content of the fracturing fluids without additional borate crosslinker were 126 mg/L for the Formation water and 145 mg/L for the Flowback water. Given that the in situ boron (as B) content of the waters were 145 mg/L and 126 mg/L, respectively, and that successful distilled water Control and Freshwater crosslinked fluids were formed with the Total Boron content ranging from about 130 to about 143 mg/L, it was thought that sufficient in situ boron might be present to develop a crosslinked fracturing fluid with viscosity performance comparable to the Control and Freshwater examples of Example 1. As with the previous examples, the fracturing fluid was evaluated at 220° F. Crosslinking was observed to be very fast but not nearly as robust as in both Formation and Flowback water fluids, neither fluid provided for a sustained crosslinked performance comparable to the distilled water control or the Freshwater case.

### Example 4

### Reduced Boron Addition

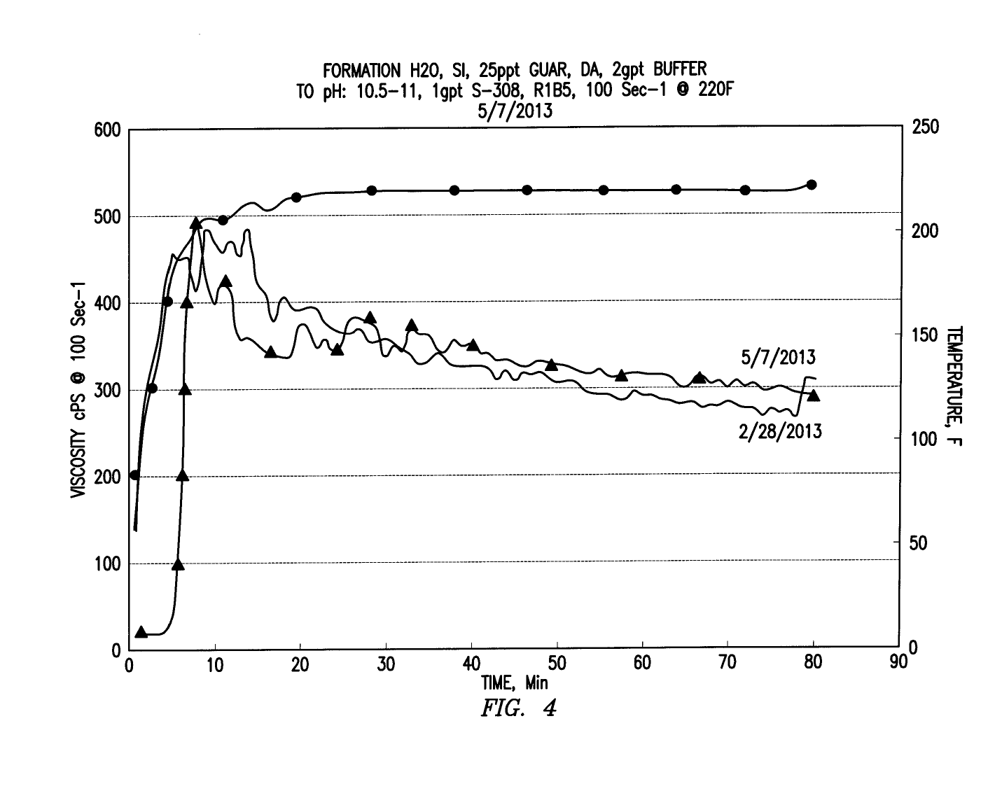

As with Example 2, a portion of sample 3 (Formation water) was evaluated as a water source for a fracturing fluid on a Grace M5500 HTHP Viscometer using methods referenced in ISO 13503-1 (Sep. 1, 2003), Part 1: Measurement of Viscous Properties of Completion Fluids. The fracturing fluid comprised sample 3 water and all the additives used in the previous examples and at the same concentrations, except that only 1 gallon per 1000 gallons (gpt) equivalent of the borate crosslinker was added. Additionally, 1 to 2 gpt equivalent of a hardness ion scale inhibitor (SI) and a crosslinking delay agent (DA) were added. The guar loading was also increased over the previous samples by 5 pounds per 1000 gallons (ppt) equivalent to bring the total polymer loading to 25 ppt. A borate cross-linker, (S-308 available from Rockwater Energy Solutions, Houston, Tex.), was added to the mixture, at an equivalent of 1 gpt. The mixture was then buffered to a pH of between pH 10.5 and 11 using a potassium carbonate solution. The viscosity of the crosslinked fluid was measured at 220° F. to provide the performance response shown in FIG. 4. As shown in FIG. 4, the in-situ boron (as B) content of the Formation waters are 126 and 140 mg/L, respectively, and the total boron (as B) content of the crosslinked fracturing fluids are 191 to 198 mg/L, and 205 to 212 mg/L, respectively. A first test was performed using a Formation water containing 140 mg/L in situ boron (as B). A second test was performed using the Formation water of sample 3, containing 126 mg/L boron (as B). In both cases the in situ boron (as B) was >20 mg/L, which is twice the upper limit set by most operators and fracturing fluid service providers for oilfield waters suitable for use as frac make-up waters. In both of these cases the in-situ boron content was greater than 12 times the typical upper limit of 10 mg/L boron. In both of these cases, the total boron content of the fracturing fluid following the addition of a borate crosslinker was about 50 to 70 mg/L greater than the total boron content of the Control and Freshwater borate crosslinked fluid standards. In both cases, the amount of borate crosslinker added to form a comparably performing fracturing fluid was less (by ½) of the crosslinker loading of the Control and Freshwater borate crosslinked fluid standards, indicating that some utilization of the in situ boron content of the Formation waters to form the fracturing fluids had occurred. As only a portion of the in-situ boron was utilized in the formation of the fracturing fluid, the remainder of the boron comprising the total boron content is unavailable for use in the fracturing fluid, i.e., “sequestered.”

### Example 5

### Reduced Boron Addition

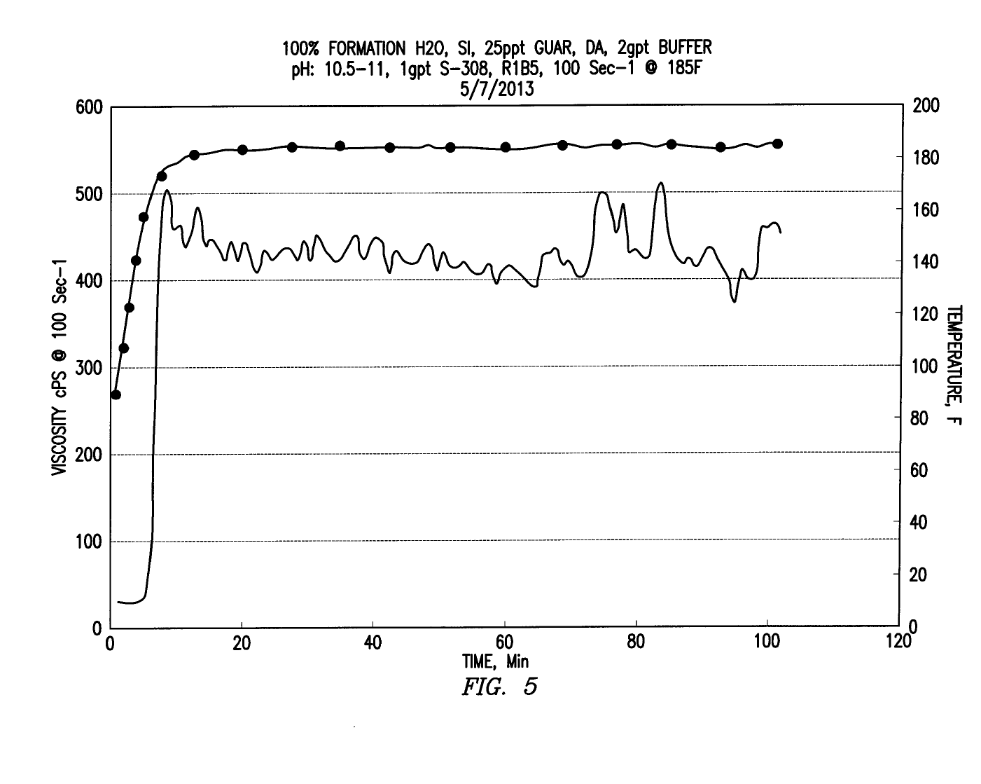

A portion of sample 3 (Formation water) was evaluated as a water source for a fracturing fluid on a Grace M5500 HTHP Viscometer using methods referenced in ISO 13503-1 (Sep. 1, 2003), Part 1: Measurement of Viscous Properties of Completion Fluids. The fracturing fluid comprised sample 3 water and all the additives used in the previous Example 4, i.e., 1 gallon per 1000 gallons (gpt) equivalent of the borate crosslinker, and 1 to 2 gpt equivalent of a hardness ion scale inhibitor (SI) and a crosslinking delay agent (DA) were added. The guar loading, as in Example 4, was 25 pounds per one thousand gallons equivalent (pptg). A borate cross-linker, (S-308 available from Rockwater Energy Solutions, Houston, Tex.), was added to the mixture, at an equivalent of 1 gpt. The mixture was then buffered to a pH of between pH 10.5 and 11 using a potassium carbonate solution. The viscosity of the crosslinked fluid was measured at 185° F. to provide the performance response shown in FIG. 5. As shown in FIG. 5, the in-situ boron (as B) content of the Formation water is 126 mg/L, and the total boron (as B) content of the crosslinked fracturing fluid is 191 to 198 mg/L. The in situ boron content of Formation water of sample 3 was 126 mg/L boron (as B), and, as such, the in situ boron (as B) was >20 mg/L, which is twice the upper limit set by most operators and fracturing fluid service providers for oilfield waters suitable for use as frac make-up waters. In this case the in-situ boron content was greater than 12 times the typical upper limit of 10 mg/L boron. The total boron content of the fracturing fluid following the addition of a borate crosslinker was about 50 to 70 mg/L greater than the total boron content of the Control and Freshwater borate crosslinked fluid standards. As in the Example 4 cases, the amount of borate crosslinker added in this case to form a comparably performing fracturing fluid was less (by ½) of the crosslinker loading of the Control and Freshwater borate crosslinked fluid standards, indicating that some utilization of the in situ boron content of the Formation waters to form the fracturing fluids had occurred. As only a portion of the in-situ boron was utilized in the formation of the fracturing fluid, the remainder of the boron comprising the total boron content is unavailable, i.e., “sequestered.” The results are described in Table 2.

TABLE 2

| | | | Added | | | Max | | |
|---|---|---|---|---|---|---|---|---|
| | | In- | Boron | | | Visc. | 60 min | |
| | | situ | with | Total | Estimated | cPs @ | Visc. @ | |
| | | Boron | Crosslinker | Boron | Sequestered | 100 | 100 | |
| Example | Water | mg/L | mg/L | mg/L | Boron mg/L | sec−1 | sec−1 | Fluid Performance |
| Ex. 1 | Control | <10 | 130-143 | 130-143 | 0 | 375 | 230 | Ideal, FIG. 1 |
| Ex. 1 | Freshwater | <10 | 130-143 | 130-143 | 0 | 320 | 185 | Satisfactory. FIG. 1 |
| Ex. 2 | Flowback | 145 | 130-143 | 275-290 | ND | 6 | <10 | Unsatisfactory, FIG. 2 |
| Ex. 2 | Formation | 126 | 130-143 | 255-270 | ND | 6 | <10 | Unsatisfactory, FIG. 3 |
| Ex. 3 | Formation | 140 | 65-72 | 205-212 | 62-82 | 490 | 290 | Satisfactory, FIG. 4 |
| Ex. 3 | Formation | 126 | 65-72 | 191-198 | 48-68 | 480 | 310 | Satisfactory, FIG. 4 |
| Ex. 4 | Formation | 126 | 65-72 | 191-198 | 48-68 | 500 | 400 | Satisfactory, FIG. 5 |

What is claimed is:

1. A method of forming a fracturing fluid comprising:
mixing produced water or boron-containing oilfield water having an in-situ boron concentration greater than about 20 mg/L at the time of mixing with a hydratable boron crosslinkable polymer to form a fracturing fluid.

2. The method of claim 1, wherein the in-situ boron is boric acid, an inorganic borate, an organic borate, or combinations thereof.

3. The method of claim 1, wherein the in-situ boron content is between 20 mg/L and 2000 mg/L.

4. The method of claim 3, wherein the in-situ boron content is between 20 mg/L and 660 mg/L.

5. The method of claim 4, wherein the in-situ boron content is about 150 mg/L.

6. The method of claim 1, wherein the hydratable crosslinkable polymer is selected from the group consisting of guar, hydroxyethylguar, hydroxypropylguar, carboxymethylguar, carboxymethylhydroxyethylguar, carboxymethylhydroxypropylguar and mixtures thereof.

7. The method of claim 1, wherein the concentration of the boron in the fracturing fluid is from 20 mg/L to 500 mg/L.

8. The method of claim 7, wherein the concentration of the boron in the fracturing fluid is from 100 mg/L to 200 mg/L.

9. The method of claim 1 further comprises adding a boron compound to the fracturing fluid.

10. The method of claim 9, wherein the boron compound is selected from the group consisting of boric acid, organic borates, inorganic borates, and mixtures thereof.

11. A fracturing fluid comprising:
produced water or boron-containing oilfield water having an in-situ boron concentration greater than about 20 mg/L; and
a hydratable boron-crosslinkable polymer.

12. The fracturing fluid of claim 11 further comprising an added boron compound.

13. The fracturing fluid of claim 11, wherein the concentration of the boron in the fracturing fluid is greater than 20 mg/L.

14. The fracturing fluid of claim 13, wherein the in-situ boron is boric acid, an inorganic borate, an organic borate, or combinations thereof.

15. The fracturing fluid of claim 11, wherein the hydratable crosslinkable polymer is selected from the group consisting of guar, hydroxyethylguar, hydroxypropylguar, carboxymethylguar, carboxymethylhydroxyethylguar, carboxymethylhydroxypropylguar and mixtures thereof.

16. A method of manufacturing a fracturing fluid comprising:
determining the in-situ concentration of boron of produced water or boron-containing oilfield water having an in-situ boron concentration greater than about 20 mg/L;
mixing produced water or boron-containing oilfield water with a hydratable crosslinkable polymer, wherein the in-situ boron concentration of the produced water or boron-containing fresh water is greater than about 20 mg/L at the time of mixing to form a water/polymer mixture;
determining the difference between the concentration of boron in the produced water or boron containing fresh water and the desired boron concentration of the fracturing fluid; and
adding a boron compound to the water/polymer mixture to form a fracturing fluid.

17. The method of claim 16 further comprising prior to the step of adding a boron compound to the water/polymer mixture the step of adjusting the pH of the water/polymer mixture to a pH of between 5.0 and 6.5.

18. The method of claim 17 further comprising after the step of adding a boron compound to the water/polymer mixture the step of adjusting the pH of the fracturing fluid to a pH of between 8.5 and 12.

19. The method of claim 16 further comprising before the step of mixing produced water or boron-containing oilfield water with a hydratable crosslinkable polymer the step of softening the produced water or boron-containing oilfield water.

20. The method of hydraulically fracturing a subterranean formation comprising the steps of forming the fracturing fluid of claim 11; and
pumping the fracturing fluid into a well penetrating a subterranean formation with sufficient rate and pressure to form at least one fracture into the rock comprising the subterranean formation.

21. A method of manufacturing a fracturing fluid comprising:
determining a desired performance characteristic for the fracturing fluid;
mixing produced water or boron-containing oilfield water having an in-situ boron concentration greater than about 20 mg/L with a hydratable crosslinkable polymer, wherein the in-situ boron concentration of the produced water or boron-containing fresh water is greater than about 20 mg/L at the time of mixing to form a water/polymer mixture; and
adding a boron compound to the water/polymer mixture to form a fracturing fluid with the desired performance characteristic.

22. A method of manufacturing a fracturing fluid comprising:
determining the in-situ concentration of boron of produced water or boron-containing oilfield water having an in-situ boron concentration greater than about 20 mg/L;
mixing produced water or boron-containing oilfield water with a hydratable crosslinkable polymer, wherein the in-situ boron concentration of the produced water or boron-containing fresh water is greater than about 20 mg/L at the time of mixing to form a water/polymer mixture;
determining the difference between the concentration of boron in the produced water or boron containing fresh water and the desired boron concentration of the fracturing fluid;
forming a diluted produced water stream, wherein the diluted produced water stream has an in-situ boron concentration of great than about 20 mg/L; and
adding the diluted produced water stream to the water/polymer mixture to form a fracturing fluid.
